(19) United States
(12) Patent Application Publication
(10) Pub. No.: US 2004/0190129 A1
(43) Pub. Date: Sep. 30, 2004

(54) Device and method for controlling functions of a microscope system

(75) Inventors: Katja Peter, Rechtenbach (DE); Frank Toennissen, Bottrop (DE); Christian Knoll, Stuttgart (DE); Dietmar Kempf, Schonaich (DE)

Correspondence Address: SIMPSON & SIMPSON, PLLC, 5555 MAIN STREET, WILLIAMSVILLE, NY, 14221-5406, US

(73) Assignee: Leica Microsystems Wetzlar GmbH, Wetzlar (DE)

(21) Appl. No.: 10/773,952

(22) Filed: Feb. 6, 2004

(30) Foreign Application Priority Data
Feb. 7, 2003 (DE) DE 103 05 117.1

(51) Int. Cl. G02B 21/00; G02B 21/06

(52) U.S. Cl. 359/368; 359/390

(57) ABSTRACT

A device for controlling functions of a microscope is disclosed, the microscope system encompassing a stand base part (3). A central display (8) is integrated into the stand base part (3). The display (8) contains an operating menu (20) and an information mode (25), the operating menu (20) being constructed from a first region (211), a second region (221), and a third region (222). A main menu (21) is displayable in the first region (211), a submenu (22) in the second region (221), and information and action elements in the third region (222), the third region (222) being delimited on one side by the main menu (21) and on one side by the submenu (22), and the entire display (8) being usable for presentation in the information mode (25).

### CROSS-REFERENCE TO RELATED APPLICATIONS

This application claims priority of the German patent application 103 05 117.1 which is incorporated by reference herein.

### FIELD OF THE INVENTION

The present invention concerns a device for controlling microscope functions. The invention also concerns a method for controlling functions of a microscope system.

### BACKGROUND OF THE INVENTION

The Nikon Eclipse E1000, Olympus BX 61, and Zeiss Axioskop 2FS are, substantially, microscopes with which various settings can be made. In all these systems, the current settings and active components are not directly visible to the user. The user must check everything individually. From the settings, the user must deduce the microscopy method currently being used. Dependent components must be activated or adjusted, and coordinated with one another, using switches and controllers that have no physical relationship. Dependent components must be individually activated. Dependent components are not checked for compatibility, i.e. no plausibility check is performed to ensure an appropriate and functional combination of system components. The operating sequence is not unequivocal; it is dependent on the individual user's procedure and must be learned. The LCD or LED displays in the microscope systems do not offer a return message regarding compatible system components or appropriate combinations. With the existing microscope systems, upper and lower limits can be set and the increment for focusing can be set as a function of the selected objective. The adjustment is performed via switches and a display on the selected values on the LCD or LED display. Frequently used system settings cannot be saved.

### SUMMARY OF THE INVENTION

It is therefore the object of the invention to create a microscope system that solves the problems of the existing art. The object of the invention is, in particular, to create a microscope system which quickly informs a user thereof regarding its configuration and settings, and also indicates compatible settings.

The object is achieved, according to the present invention, by a device for controlling functions of a microscope system, comprising: a stand base portion of a microscope, a central display integrated into the stand base portion, wherein the central display is used to perform all settings of the microscope system, to call saved settings of the microscope system and to receive warning messages or notifications from the microscope system.

A further object of the invention is to create a method that performs the settings centrally, communicates information to the user, and provides assistance in setting up the microscope system. The method is moreover intended to make operation of the microscope system considerably easier and more user-friendly.

The object is achieved, according to the present invention, by a method for controlling functions of a microscope system, comprising the steps of:

providing a display integrated into a stand base part of the microscope system;

activating the display and thereby displaying an operating menu and information mode, wherein the operating menu being constructed from a first region, a second region, and a third region;

displaying a main menu in the first region,

displaying a submenu the second region,

displaying information and action elements in the third region, wherein the third region being delimited on one side by the main menu and on one side by the submenu; and

using the entire display for presentation in the information mode.

The invention has the advantage that an interactive menu interface for controlling all important microscope functions is provided. The current settings, the microscopy method, and the active components are displayed to the user in an overview menu. Selection of the microscopy method and adjustment of system components are performed centrally on the display (touchscreen). The settings for a microscopy method are implemented largely automatically by the system, and all necessary components such as the objective, filters, prisms, etc. are automatically brought into the beam path and adjusted. In some cases, fine adjustments to the active components by the user are still necessary (e.g. orientation of prisms). The input sequence procedure reflects the user's operating sequence. Individual operating sequence preferences remain unaffected and can be retained. In order to set a certain microscopy method, the user initially needs only to select the corresponding method and the desired objective. The user is given instructions regarding appropriately combinable components of the system. All microscope methods and system components available in the system are displayed, and can be selected and activated at any time. The user can decide which method or which system components he or she wishes to use, regardless of whether that component is compatible with the current system settings. If an incompatible component is selected, the user is informed of that and is assisted with further settings to achieve a functional system state. The-memory function for saving system settings for the various microscopy methods allows the user to quickly activate frequently used microscope settings or microscopy methods. All necessary components such as the objective, filters, prisms, etc. are automatically brought into the beam path. The focus plane can optionally also be saved. The memory function for stage position in the X and Y directions allows the storage of various image areas of relevant regions of a sample, allowing particularly interesting regions of a sample to be rapidly recalled and moved to.

The navigation bars make it possible at any time to change the main menu, which in turn is subdivided by the tabs into submenus. Since the buttons for the sub-main menus and the tabs in the submenus always remain visible, quick comprehension of one's current position in the menu is guaranteed. Every value change (manipulations within a main menu) must be confirmed with “OK” in order to prevent operator errors. “BACK” retrieves the last six pages viewed, while “UNDO” annuls value changes that have already been confirmed with “OK.”

A high level of language independence is achieved by the use of pictograms and symbols, most of them newly developed. For easy comprehension of the operating state, selected and active switches or buttons are displayed in inverted mode.

The menu always displays all the options contained in the system, even if they are not available based on current operating conditions. Those function keys whose selection is compatible with current operating conditions are labeled with a triangle in the button (“recommended selection”). The menu is constructed in three hierarchical levels, the important functions being located directly in the main menu. The additional menu levels are necessary so that for certain functions, further parameters necessary for implementing them in the microscope system can be set.

Further advantageous embodiments of the invention are evident from the dependent claims.

### BRIEF DESCRIPTION OF THE DRAWINGS

The invention will be elucidated below with reference to the examples depicted schematically in the Figures, in which:

FIG. 1a is a perspective view of a microscope that encompasses the device according to the present invention;

FIG. 1b is a detail view of the display provided in the microscope stand, on which an operating menu is schematically depicted;

FIG. 2 is a graphic depiction of a structure of all main menus and submenus on which control of the microscope is based;

FIG. 3 depicts the start page that is shown on the microscope display;

FIG. 4a shows a setup display for displaying the general settings of the microscope system;

FIG. 4b shows a setup display for displaying the settings (not to be performed in the menu) for the microscope system illumination;

FIG. 4c shows a setup display for displaying the assignment of the function keys on the left side of the microscope system stand;

FIG. 4d shows a setup display for displaying the assignment of the function keys on the right side of the microscope system stand;

FIG. 5a depicts the contrast menu for transmitted light;

FIG. 5b depicts the contrast menu for incident light;

FIG. 5c depicts the contrast menu for special contrasting techniques;

FIG. 5d shows selection of the fluorescence menu that is reachable via the “Contrast menus for incident light” submenu;

FIG. 5e shows selection of the diaphragms in the fluorescence menu;

FIG. 5f depicts a compatibility message in the contrast menu;

FIG. 5g depicts a compatible selection in the contrast menu;

FIG. 6a depicts the objective menu for dry objectives;

FIG. 6b depicts the objective menu for immersion objectives;

FIG. 6c depicts the objective menu for secondary magnification with reference to the camera port;

FIG. 6d depicts the objective menu for secondary magnification with reference to the eyepiece port;

FIG. 6e depicts a compatibility message in the objective menu;

FIG. 6f depicts a compatible selection in the objective menu;

FIG. 7a depicts the port menu with the setting of the currently set viewing port;

FIG. 7b depicts the state when “LCD OFF” on the port menu has been pressed;

FIG. 8a depicts the start page for the memory functions;

FIG. 8b depicts a security inquiry that protects occupied memory locations from being overwritten;

FIG. 8c depicts a security inquiry that indicates empty memory locations to the user;

FIG. 8d depicts the memory menu with an indication of the stored X/Y positions of the stage;

FIG. 8e depicts the memory menu for saving a focus plane (Z position);

FIG. 8f depicts the memory menu with a display of the saved focus planes (Z positions);

FIG. 8g depicts the start page for saving system settings;

FIG. 8h depicts the memory menu for clearing and/or saving system settings;

FIG. 8i depicts the memory menu for saving the current settings;

FIG. 8j depicts the memory menu for calling a saved system setting;

FIG. 8k depicts the memory menu for renaming the keys for saved system settings;

FIG. 9a depicts the configuration menu with which the basic device and system settings are made;

FIG. 9b depicts the configuration menu for menu settings;

FIG. 9c depicts the configuration menu for display settings;

FIG. 9d is a first depiction of the configuration menu for initial setup of the microscope;

FIG. 9e is a second depiction of the configuration menu for initial setup of the microscope, for installing objectives;

FIG. 9f is a third depiction of the configuration menu for initial setup of the microscope, for installing objectives;

FIG. 9g is a fourth depiction of the configuration menu for initial setup of the microscope, for installing objectives;

FIG. 9h depicts the configuration menu for initial setup of the microscope, for inserting covers;

FIG. 9i depicts the configuration menu for completing objective installation;

FIG. 9j is a first depiction of the configuration menu for installing the fluorescence filters;

FIG. 9k is a second depiction of the configuration menu for installing the fluorescence filters;

FIG. 9l is a third depiction of the configuration menu for installing the fluorescence filters;

FIG. 9m is a fourth depiction of the configuration menu for installing the fluorescence filters;

FIG. 9n depicts the configuration menu for completing installation of the fluorescence filters;

FIG. 10a depicts the objective menu for dry objectives, for a non-motorized objective turret;

FIG. 10b depicts the objective menu for immersion objectives, for a non-motorized objective turret;

FIG. 11a is a first depiction of the configuration menu for initial setup of the microscope, for installing objectives on a non-motorized objective turret;

FIG. 11b is a second depiction of the configuration menu for initial setup of the microscope, for installing objectives on a non-motorized objective turret;

FIG. 11c is a third depiction of the configuration menu for initial setup of the microscope, for installing objectives on a non-motorized objective turret;

FIG. 11d is a fourth depiction of the configuration menu for initial setup of the microscope, for installing objectives on a non-motorized objective turret;

FIG. 11e is a fifth depiction of the configuration menu for initial setup of the microscope, for installing objectives on a non-motorized objective turret;

FIG. 11f is a sixth depiction of the configuration menu for initial setup of the microscope, for installing objectives on a non-motorized objective turret;

FIG. 11g is a seventh depiction of the configuration menu, for outputting a warning if the objective is not inserted correctly into the non-motorized objective turret;

FIG. 11h depicts the configuration menu for initial setup of the microscope with a non-motorized objective turret, for the insertion of covers; and

FIG. 11i depicts the configuration menu for completing objective installation on a non-motorized objective turret.

### DETAILED DESCRIPTION OF THE INVENTION

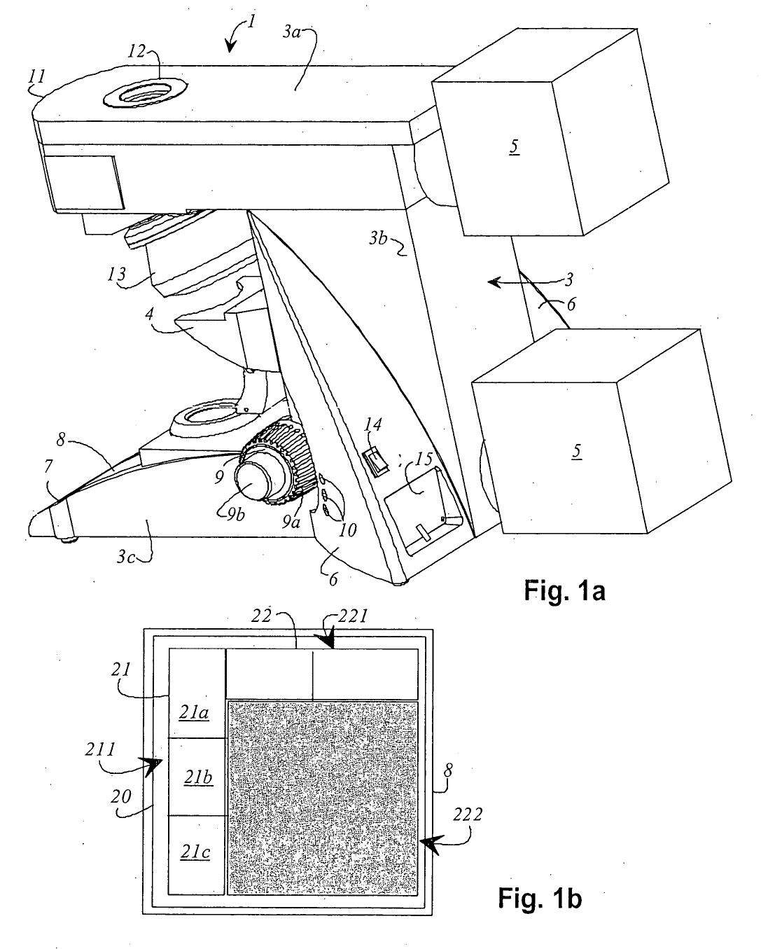

FIG. 1a shows a microscope 1 having a stand base part 3. Stand base part 3 is divided into three main sections that comprise a transverse main section 3a, a stand column section 3b, and a stand base section 3c. A microscope stage retaining element 4, on which an X/Y stage is mounted, is attached to stand column section 3b. At least one light source 5 is provided on stand column section 3b opposite microscope stage retaining element 4. In the exemplary embodiment depicted here, two light sources 5 are provided. One of light sources 5 is responsible for transmitted-light illumination, and the other light source 5 for incident-light illumination. Transverse main section 3a, stand base section 3b, and stand column section 3c are configured in such a way that they possess substantially the same width. A support element 6 is embodied on both sides of the stand in the region of stand column section 3c. It is particularly significant that in the region of stand base section 3c, each of support elements 6 exceeds it in width.

Stand base section 3c is convexly curved in the region opposite stand column section 3b, and possesses a display 8 in convexly curved region 7. In the preferred embodiment, display 8 is embodied as a touchscreen with which the user can make parameter inputs or call up certain measurement methods. If display 8 is not embodied as a touchscreen, current setting data of microscope 1 are then depicted visually via display 8. In addition, there is provided in the transition region between stand base section 3c and support element 6, on at least one side, a respective drive knob 9 that, for example, adjusts microscope stage retaining element 4 vertically (Z position or focus position). Drive knob 9 comprises a first and a second coaxially arranged rotary element 9a and 9b. One of the rotary elements is responsible for fine adjustment of the X/Y stage or of microscope stage retaining element 4. The other rotary element is responsible for coarse adjustment. It has proven particularly advantageous to allocate fine adjustment to first rotary element 9a and coarse adjustment to second rotary element 9b. It is likewise conceivable additionally to assign other functions to drive knob 9. Provided, in the region around drive knob 9 are multiple actuation elements 10 with which microscope functions can likewise be switched. Actuation elements 10 are embodied as pushbuttons. The microscope functions are, for example, filter changing, diaphragm selection, turret movement, etc. Embodied on front portion 11 of transverse main section 3a is an eyepiece flange 12 which creates an optical connection to a turret 13 on which at least one objective (not depicted) can be mounted. A power switch 14 and a connector element 15 are provided on one support element 6. Microscope 1 can be connected via connector element 15 to multiple external operating elements. There likewise exists the possibility of connecting data lines (not depicted) to connector element 15. The microscope system is connected to a computer (not depicted). The computer can be integrated into stand base part 3 or can be connected to the microscope system as an extra box. In the microscope system itself, a plurality of motors and multiple codes or sensors are provided. The motors serve to adjust, for example, the fluorescence filter wheel or objective turret, for X/Y stage adjustment, Z adjustment of the stage (focus), etc. The codes and sensors ensure that the microscope system detects whether elements have been added to the microscope system, and which ones. Elements that can be added to the microscope system are, for example, a wide variety of objectives (dry objectives, immersion objectives), fluorescence filters, other optical filters, etc. Upon initial installation (configuration), a software program implemented in the computer learns how the microscope system is equipped, and can continually refer back to that information during operation. By way of display 8, the software program informs the user as to which configuration is best suited for the intended examination.

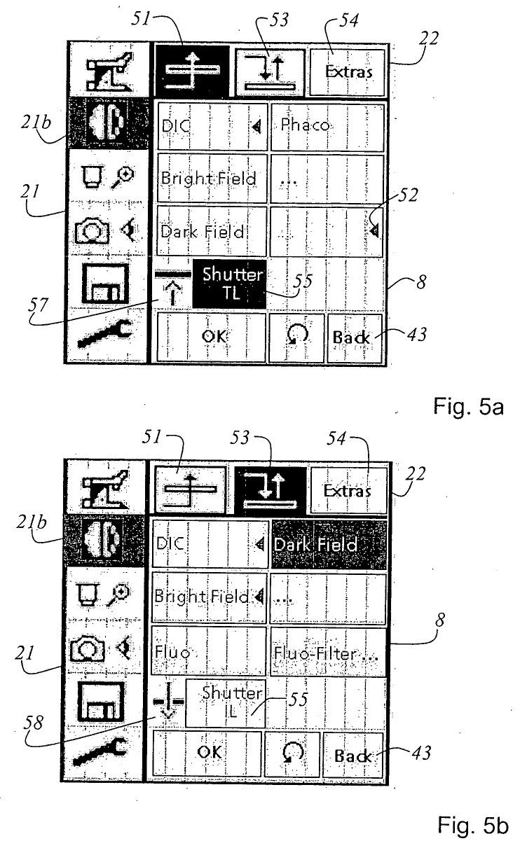

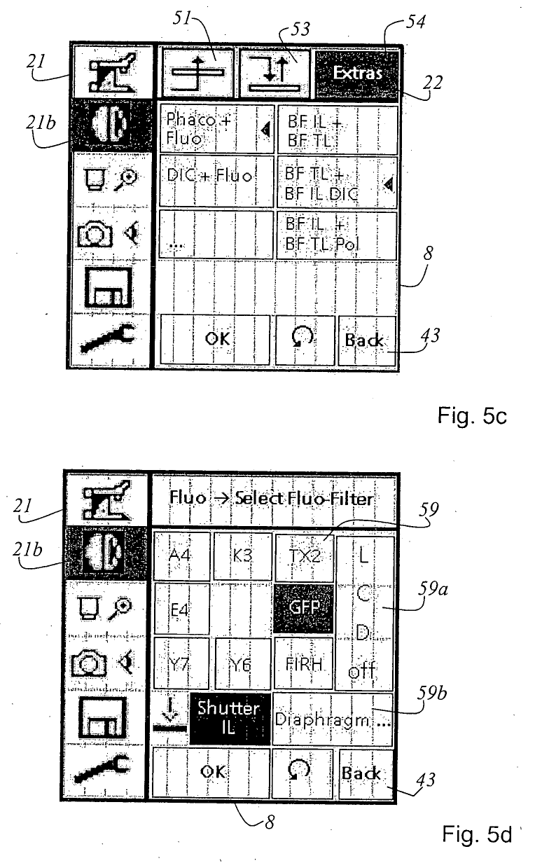

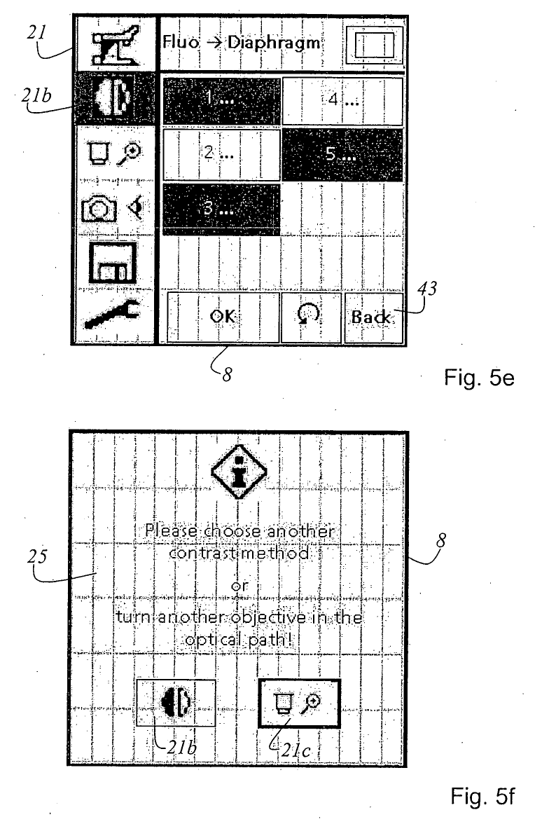

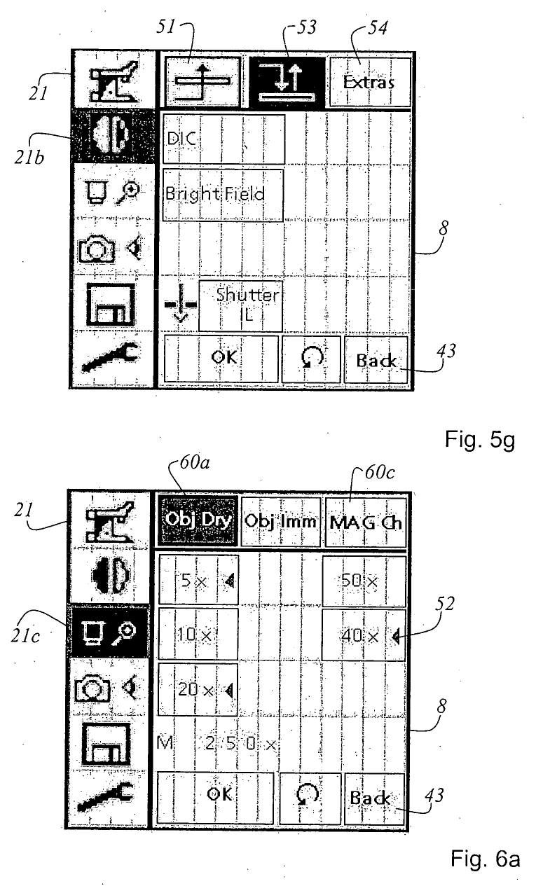

FIG. 1b is a detail view of display 8 that is provided in the microscope stand. An operating menu 20 is depicted schematically on display 8. Display 8 additionally possesses an information mode 25 (see FIG. 5f). Operating menu 20 comprises a first region 211, a second region 221, and a third region 222. A main menu 21 is located in first region 211 and a submenu 22 in second region 221, and information and action elements are displayable in third region 222. Third region 222 is delimited on one side by main menu 21 and on one side by submenu 22. In information mode 25, the entire display 8 is used for presentation. Operating menu 20 is subdivided into a main menu 21 and at least one submenu 22, and has a clear separation and hierarchy of functions. Multiple sub-main menus 21a, 21b, 21c, which can be selected individually by the user, are available in main menu 21. Selection by the user causes a submenu 22 corresponding to the respective selected sub-main menu to be displayable. Sub-main menus 21a, 21b, 21c, . . . are symbolized by icons (see Figure description below) and are present in every operating state. The only exceptions, as embodied in information mode 25, are system messages that occupy the entire display 8.

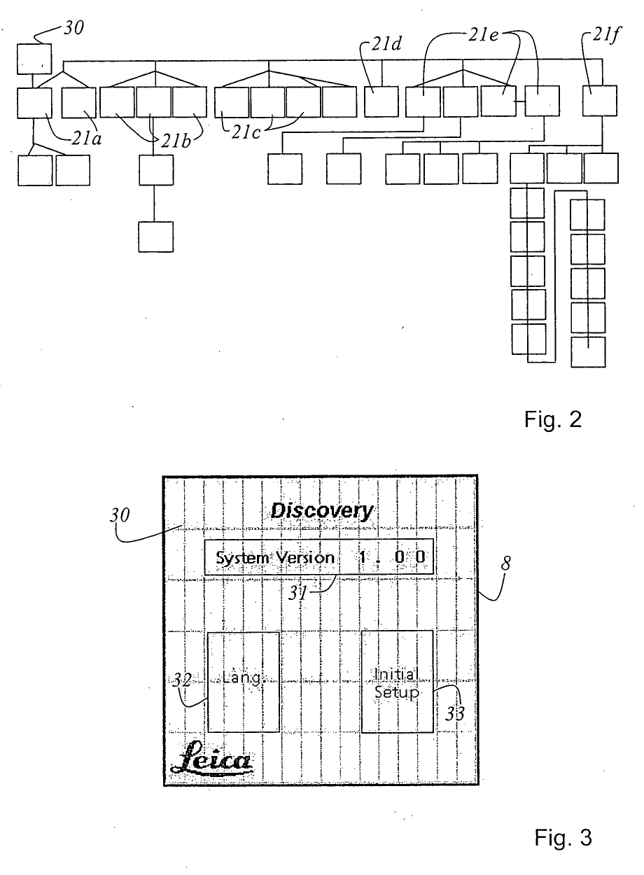

FIG. 2 shows a main menu structure that is the basis for controlling the microscope system. In a preferred exemplary embodiment, main menu 21 comprises six different sub-main menus. A first sub-main menu 21a is a setup display. First sub-main menu 21a is preceded by a start page 30 (see FIG. 3). A second sub-main menu 21b is a contrast menu. A third sub-main menu 21c is an objective menu. A fourth sub-main menu 21d is a port menu. A fifth sub-main menu 21e is a memory menu. A sixth sub-main menu 21f is a configuration menu. FIG. 3 depicts start page 30 that is displayed on display 8 of the microscope. Start page 30 occupies the entire display 8. Start page 30 appears once each time the microscope is switched on and displays the firmware version in a first region 31; by way of a first selection button 32 it allows language selection (“Lang.”) for country adaptation, (optionally also for target group adaptation, e.g. displaying abbreviations or written-out words and parts of words), and it has a selection button 33 with which initial configuration of the microscope system is performed. If no selection is made by the user, the previously set or preset language is used. After a certain period of time with no input by the user (time-out), the preset language is automatically used.

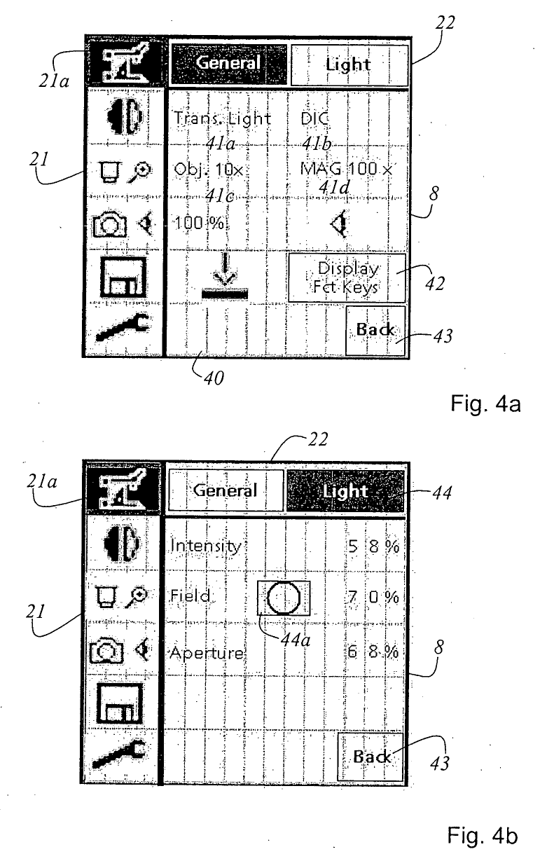

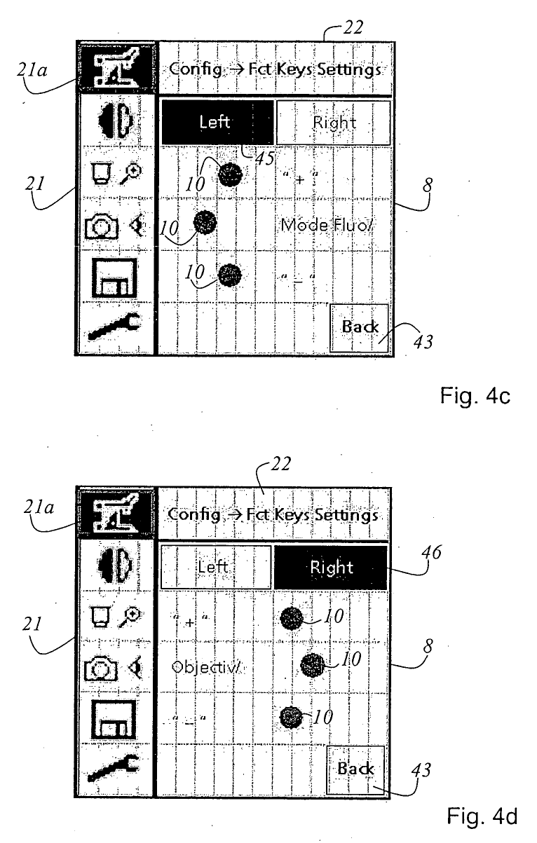

FIGS. 4a through 4d depict setup displays for general microscope system settings. The entire operating state of the microscope system can be quickly ascertained here. In each of FIGS. 4a through 4d, submenu 22 that is currently active, or the function that is currently active, has a dark background. First sub-main menu 21a that is presently active in main menu 21 on the left side of display 8 likewise has a black background. First sub-main menu 21a—the setup display for general settings—is depicted as a stylized microscope. FIG. 4a shows a setup menu 40 for general system settings. The button labeled “General” is activated, so that general system settings are displayed. In the region of display 8 not occupied by main menu 21 and submenu 22, contrasting technique 41b that is currently set and the current light path 41a are displayed. Light path 41a that appears on display 8 is “Trans. Light”, which indicates transmitted-light illumination. Contrasting technique 41b that appears on the display is “DIC”, which means differential interference contrast. A further display is objective 41c that is currently located in the beam path, and secondary magnification 41d which is labeled “MAG”. The selected port 41e is displayed; a stylized eye indicates that the eyepiece port is presently being used. The percentage figure is an indication that 100% of the light coming from the specimen is being directed to the eyepiece. In addition to a button 42 labeled “Display Fct Keys” for displaying the functions that can be activated with the function keys, the illumination mode is reproduced in stylized fashion as a pictogram. In the present case, incident-light illumination is depicted. A button 43 labeled “Back” can be used at any time to jump back to what was previously displayed on display 8. It should be noted that in the depiction of the various displays, elements having identical functions or identical meanings are shown with the same reference characters.

FIG. 4b depicts the current light settings. In this depiction, actuation button 44 labeled “Light” is activated. The label “Intensity” indicates the intensity, this once again being indicated as a percentage. In the present case, 58% of the light intensity is being used. The label “Field” denotes the field diaphragm. The type of field diaphragm is displayed alongside the “Field” label, and “70%” means that the diaphragm is 70 percent open. In the present case, field diaphragm 44a located in the beam path is round. The aperture diaphragm is labeled “Aperture”, and a percentage is also associated with the aperture diaphragm. The aperture diaphragm is 68% open.

When button 42 labeled “Display Fct Keys”, depicted in FIG. 4a, is pressed, the setup display depicted in FIG. 4c, showing the assignment of function keys 10 on the left side of the microscope system stand, appears. The fact that function keys 10 on the left side of the stand are being displayed on display 8 is apparent to the user from the dark background of actuation button 45 labeled “Left”. In the present case, the assignment for the middle function key is labeled “Mode Fluo”. The upper function key has, for example, a “+” associated with it, indicating a clockwise rotation of the filter wheel. The lower function key has, for example, a “−” associated with it, indicating a counterclockwise rotation of the filter wheel.

FIG. 4d depicts the setup display for showing the assignment of function keys 10 on the right side of the microscope system stand. The fact that function keys 10 on the right side of the stand are being displayed on display 8 is apparent to the user from the dark background of actuation button 46 labeled “Right”. In the present case, the assignment for the middle function key is labeled “Objective”, referring to the objectives provided and arranged in the turret. The upper function key has, for example, a “+” associated with it, indicating a clockwise rotation of the filter wheel. The lower function key has, for example, a “−” associated with it, indicating a counterclockwise rotation of the filter wheel.

FIGS. 5a through 5g depict the contrast menus with the associated submenus. In contrast menu 21b, the available contrasting techniques for incident light and transmitted light 51 (see FIG. 5a) can be selected in submenus 22. Triangles 52 that are associated with the various indications in display 8 serve here as a recommendation for contrasting techniques compatible with previous settings (e.g. objectives in use). The corresponding submenu for incident light 53 gives access, in the case of biological microscopes, to the fluorescence method setting region. Here a selection is made of filter blocks (for biological microscopes) and reflector blocks (for industrial microscopes); in addition, the shutter is opened and closed and the display is deactivated. These functional groups conform to the most frequent operating patterns, and eliminate the need for frequent menu changes. With “Extras” button 54 in submenu 22 it is possible to implement special contrasting techniques, e.g. simultaneous implementation of different incident- and transmitted-light methods.

FIG. 5a depicts contrast menu 21b for transmitted light, transmitted-light indication 51 once again having a dark background. Transmitted-light indication 51 is symbolized by a pictogram that depicts a light beam passing through a sample. Selection of the available contrasting techniques is depicted on display 8 in individual fields. The field labeled “DIC” stands for differential interference contrast. The field labeled “Phaco” stands for phase contrast. The field labeled “Bright Field” stands for bright field. The field labeled “Dark Field” stands for dark field. The fields can all be activated via display 8 embodied as a touchscreen. Triangles 52 in the fields represent a recommendation, and identify the contrasting techniques that are compatible with the previous system settings, in particular with the active objective (the objective provided in the microscope beam path). Opening and closing of the shutter can be activated with a button 55 labeled “Shutter TL”. The current shutter state (open/closed) is indicated by pictogram 57, which shows a blocked arrow.

FIG. 5b depicts contrast menu 21b for incident light, incident-light indicator 53 having a dark background. The indicator for the contrasting technique that is currently set is identified by a dark background. In the present case, “Dark Field” is set. As already described in FIG. 5a, triangles 52 represent a configuration recommendation. For the selection of filter settings for the fluorescence method, a separate button 50b labeled “Fluo-Filter” is offered in contrast menu 21b together with button 50a labeled “Fluo”. The shutter is opened and closed using a button 55 labeled “Shutter IL”. Indication of the current shutter state (open, in this case), is provided by pictogram 58 which shows an unblocked arrow.

FIG. 5c depicts the contrast menu for special contrasting techniques, “Extras” button 54 now having a dark background and thus being active. A combination of incident and transmitted light with contrasting techniques is accomplished using preset parameters. Triangles 52 once again mark the recommended combinations that can be combined in the context of the current settings. The contrast menu is identified by light and dark circle segments on the function switch.

FIG. 5d depicts selection of the fluorescence menu from the contrast menu. The selection of fluorescence filter blocks 59 (eight in number) is shown in a circular arrangement on display 8, corresponding to the installation location in the filter wheel. An “LCD off” button 59a is provided in order to deactivate display 8 and thus eliminate stray light. This is enormously important in particular for viewing in a darkened environment. Provided alongside button 55 labeled “Shutter IL” is a “Diaphragm” button 59b with which the diaphragm can be modified.

FIG. 5e shows selection of the diaphragms in the fluorescence menu. The standard diaphragms available for selection are shown on display 8 in the form of buttons. The currently selected standard diaphragms are apparent from their dark backgrounds.

A compatibility message is depicted in FIG. 5f. If an incompatible combination of objective and contrasting technique is invoked, the system issues a notification requesting that one of the two components be modified. The message on display 8 reads “Please choose another contrasting technique OR move a different objective into the optical path.” It is possible to switch directly into either contrast menu 21b or objective menu 21c by pushing the respective button. The system retains the old configuration until a new, compatible combination has been selected. The menu in which a further suitable component must still be selected in order to activate the desired function is shown with a flashing border on display 8 as the recommended selection. In the present case, objective menu 21c has the flashing border. It is not possible to switch into any other menu.

FIG. 5g depicts a compatible selection in the contrast menu. Here, for example, contrast menu 21b for incident light has been stipulated. Unlike in depiction 5b, only compatible contrasting techniques are displayed for selection on display 8, since this selection was initiated in 5f by pressing objective menu 21c. For this selection, it is possible to switch only among objective menu 21c, contrast menu 21b, main menu 21, and the respective submenus 51, 53, and 54. If a different menu is called, the compatibility message will once again appear. Shutter confirmation is possible, but does not take effect until compatible elements are selected. After a compatible component has been selected and confirmed with the “OK” button, the system switches back into normal selection mode.

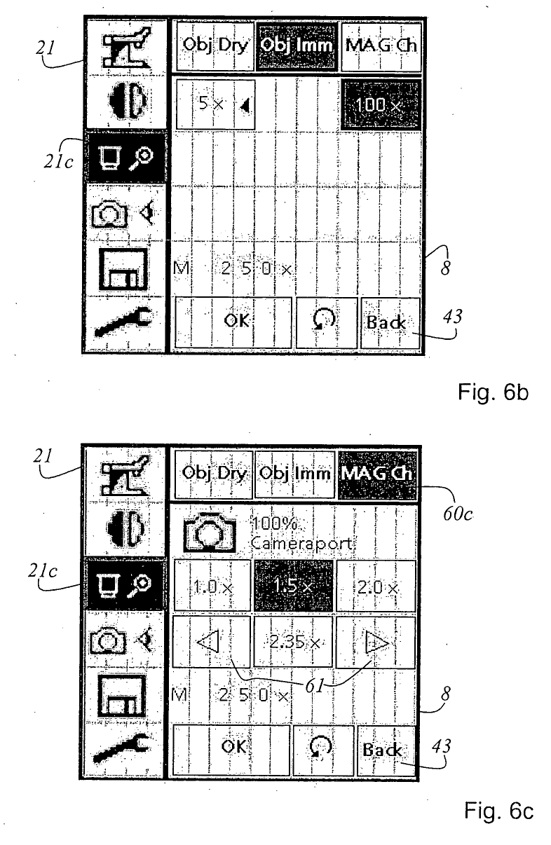

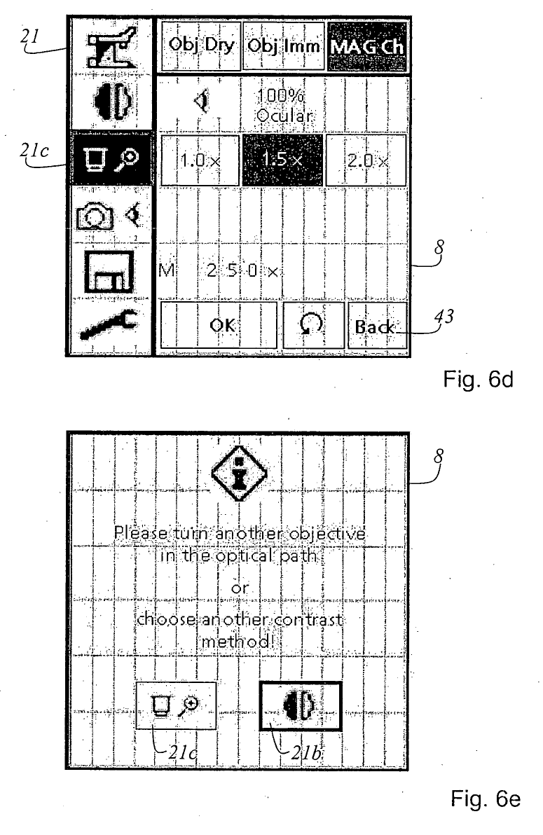

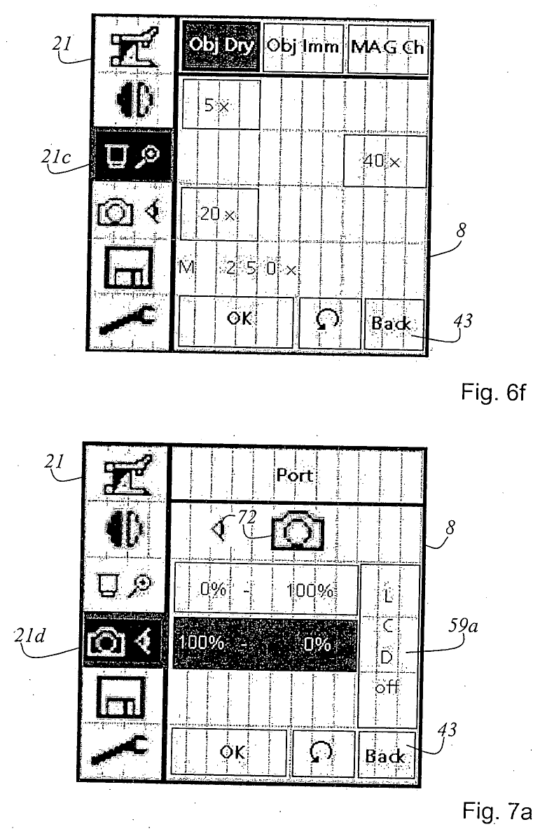

FIGS. 6a through 6f show separate submenus for dry objectives, immersion objectives, and the magnification changer. If combination objectives are also contained in the system, they are listed in both objective menus. The objective located in the light path or the working position, a selection of the available objectives, and the current total magnification are shown. Button 60c, labeled “MAG Ch”, is available for selecting secondary magnifications.

FIG. 6a depicts objective menu 21c for dry objectives. Button 60a for this purpose is labeled “Obj Dry”. The objective present in the light path is indicated by inversion of the button display. The buttons are labeled with the magnification that can be achieved with the respective objective. A selection from the available objectives is made by actuating the respective button. Triangles 52 once again indicate those objectives that are compatible with the existing system settings (e.g. contrasting technique). An indication of the current total magnification is provided below the list of available objectives. In the present case the total magnification is 250×, indicated as “M 250×”. The objective menu is identified by a stylized objective and a stylized magnifying glass on the function switch.

FIG. 6b depicts the objective menu for selecting immersion objectives. Combination objectives, e.g. in this case the objective with 5× magnification, are displayed both in objective menu 21c for dry objectives and in the menu for immersion objectives.

FIG. 6c depicts objective menu 21c for secondary magnification with reference to the camera port. Button 60c, labeled MAG Ch”, has a dark background. The indication of the currently set secondary magnification, e.g. in this case 1.5×, has a dark background, and it is possible to select from the three available fixed secondary magnifications. Adjustment using a variable zoom is also possible, and the variable zoom is controlled via arrow keys 61. The increment for adjusting the variable zoom is adapted dynamically. For a single actuation of an arrow key 61, for example, the increment is 0.05, and for a continuous actuation of an arrow key 61 the increment is 0.1. The user can determine the secondary magnification set for the camera port by way of the camera pictogram shown on display 8.

FIG. 6d depicts the objective menu for the secondary magnification with reference to the eyepiece port. The secondary magnification that is currently set is shown on display 8. The user can select from three of the available fixed secondary magnifications, and an indication of the current total magnification is provided (see also FIG. 6c). The user can determine the secondary magnification set for the camera port by way of the eye pictogram shown on display 8.

FIG. 6e depicts a compatibility message in the objective menu. If an incompatible combination of objective and contrasting technique is invoked, the system issues a notification requesting that one of the two components be modified. The message reads “Please move a different objective into the optical path OR choose another contrasting technique.” It is possible to switch directly into either contrast menu 21b or objective menu 21c by pushing the respective button. The system retains the old configuration until a new, compatible combination has been selected. The menu in which a further suitable component must still be selected in order to activate the desired function is shown with a flashing border as the recommended selection. In the present case, this is contrast menu 21b. It is not possible to switch into any other menu.

In FIG. 6f, unlike in 6a, the user is shown a depiction of a compatible selection in objective menu 21c, since this selection was initiated in 6e by pushing objective menu 21c. In the present case, the dry objectives are a selection of the compatible objectives. Only compatible objectives are displayed for selection (in this case, objectives with 5×, 20×, and 40× magnification). In this mode it is possible to switch only among objective menu 21c, contrast menu 21b, main menu 21a, and the respective submenus. If a different menu is called up, the compatibility message (see FIG. 6e) will once again appear. Once a compatible component has been selected and confirmed using the “OK” button, the system switches back into normal selection mode.

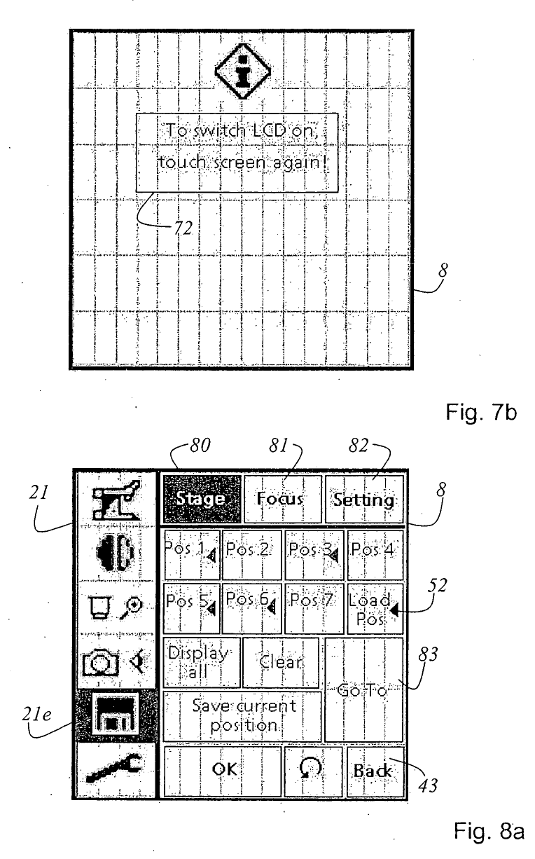

FIG. 7a depicts a port menu 21d with an indication of the currently set viewing port. Port menu 21d indicates the currently set viewing port and allows selection of the available outputs. To eliminate stray light when taking photographs, it is possible to deactivate the display using an “LCD off” button 59a. The viewing ports available for selection are depicted by pictograms 72. A stylized eye stands for observation or the eyepiece port. The pictogram of the stylized camera stands for the camera port. Deactivation of display 8 to eliminate stray light, in particular for viewing in a darkened environment and when taking photographs, is accomplished by pressing “LCD off” button 59a. The system message depicted in FIG. 7b is provided for reactivating display 8. A message 72 remains visible for only three seconds before display 8 is switched off. Message 73 reads “Touch the screen to switch on the LCD display”. Reactivation is accomplished by pressing display 8 (touchscreen).

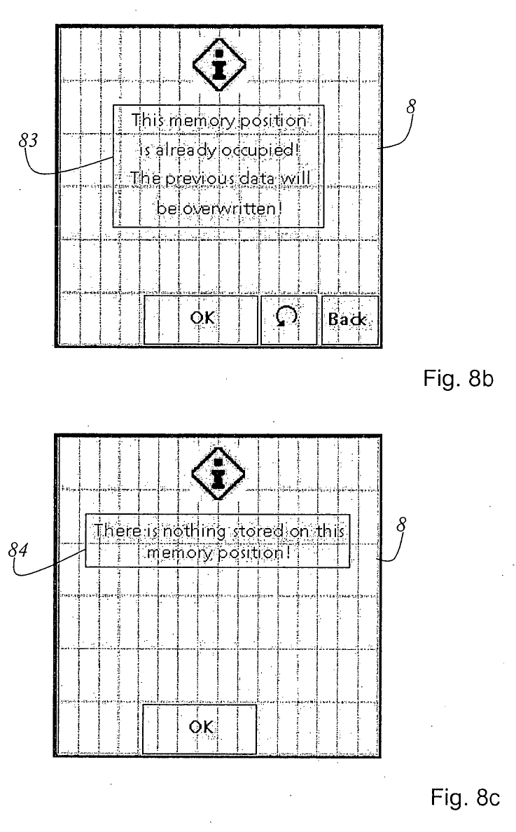

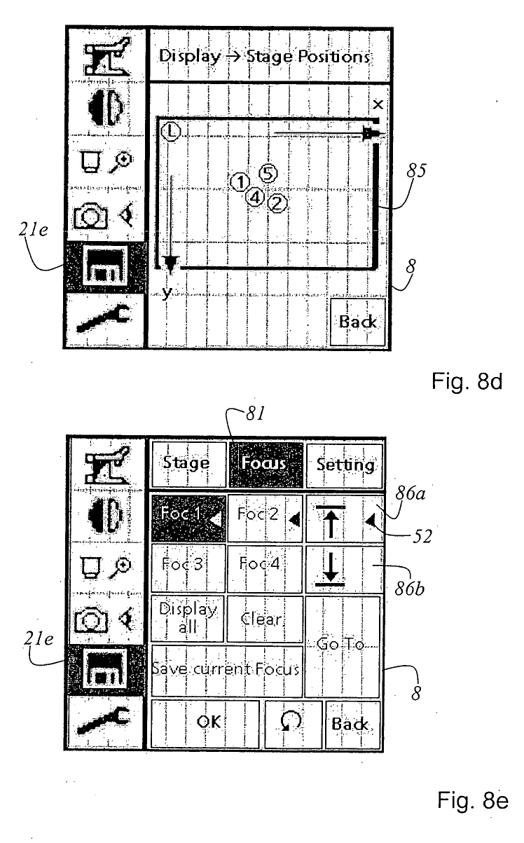

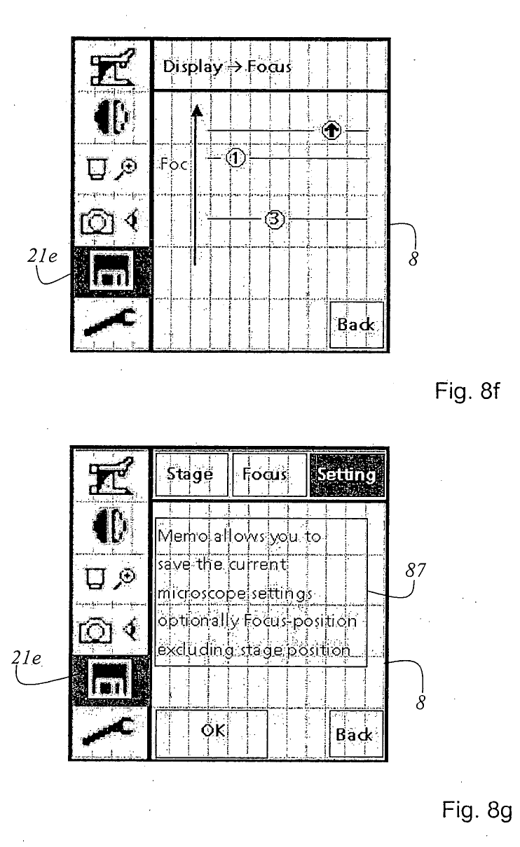

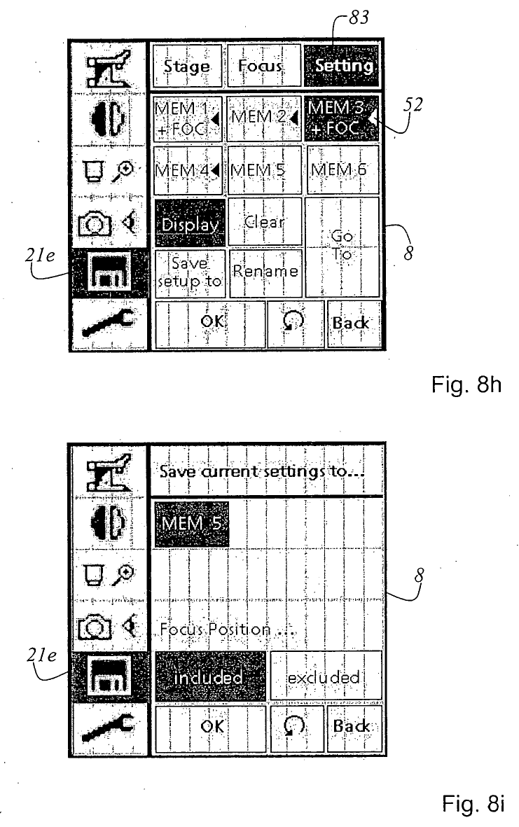

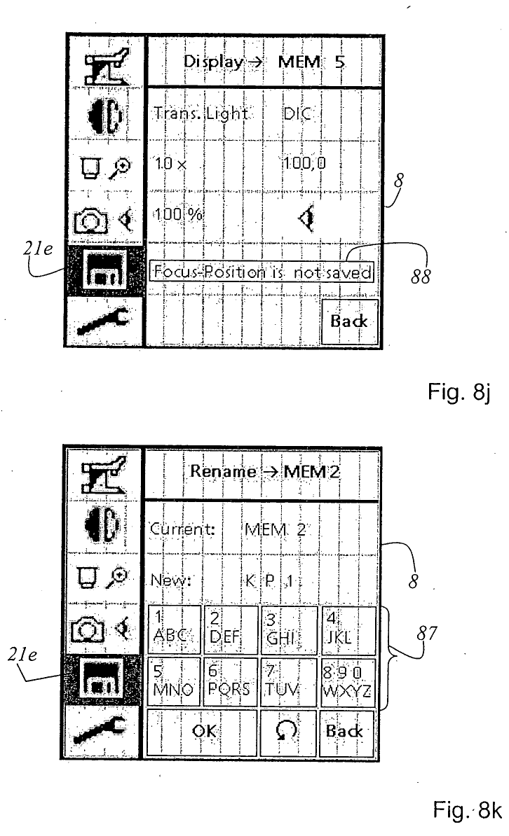

A further menu in main menu 21 is memory menu 21e (see e.g. FIG. 8a). Memory menu 21e enables a number of innovative memory functions. It shows three submenus, one for the currently saved stage positions 80 (X/Y axis, labeled “Stage”), and another for focus plane 81 (Z axis, labeled “Focus”). A maximum of eight positions and six focus planes can be set using “Stage” and “Focus”. A final menu is labeled with “Setting” button 82 and allows up to six complete operating states to be saved; the associated focus position can optionally also be saved. This enables quick changes among frequently used settings. The memory menu is identified by a stylized diskette on the function switch.

FIG. 8a depicts memory menu 21e for the various stage positions 80 (X/Y axis). The “Stage” button has a dark background to identify the activity. The procedure for setting a saved stage position (X/Y position) can be described as follows: First, one of the buttons labeled “Pos 1” through “Pos 7” must be selected. Upon actuation of a “Go To” button, the corresponding stage position (X/Y position) is moved to by pressing the “OK” button (normal mode). The procedure for saving the current stage position (X/Y position) begins with selection of the button labeled “Pos 1” through “Pos 7” or “Load Position”. Pressing the “Save current position” enables the save operation, which is confirmed by actuating the “OK” button. A triangle 52 appears on the memory location button and initially flashes for 3 seconds to visualize the save operation and to indicate the meaning of the triangle (location occupied). It is also possible to clear stored stage positions (X/Y positions). To clear a stored stage position (X/Y position), the stage position to be cleared is first selected using “Pos 1” through “Pos 7” or “Load Position”. Actuation of the “Clear” button enables the clear operation, which is confirmed by pressing the “OK” button. Occupied and callable memory locations are identified by a triangle. The “Display all” button is used to display all saved stage positions.

FIG. 8b depicts a security inquiry 83 that protects occupied memory locations from being overwritten. Occupied memory locations are protected from being overwritten by security inquiry 83, displayed separately on display 8. Security inquiry 83 is shown before a memory location is overwritten, offering the user the choice of actually overwriting the location or aborting the operation. Security inquiry 83 reads “This memory location is already occupied. The previous data will be overwritten.”

FIG. 8c depicts a security inquiry 84 that reports unoccupied memory locations to the user. When an empty memory location is invoked, the dialog outputs a message informing the user that the memory location is not occupied. Pressing the “OK” button moves the user back into the previous memory menu. Security inquiry 84 reads “There is nothing stored at this memory location.”

FIG. 8d depicts the memory menu that displays the saved X/Y positions of the stage. A display of all saved stage positions, labeled “Display→Stage Positions”, is provided on display 8 for approximate orientation, in a coordinate system or on a stylized stage 85. Memory locations located close together are not depicted at exact scale.

FIG. 8e depicts memory menu 21e for saving a focus plane 81 (Z position). The procedure for calling a saved focus plane (Z position) is comparable to that for calling a saved stage position. For the sake of completeness, however, it will be discussed in more detail. Firstly, the desired position can be selected using the “Foc 1” through “Foc 4” buttons or the “top plane” 86a and “bottom plane” 86b buttons. Pressing the “Go To” button and actuating the “OK” button confirms the selection. To save the current focus plane 81. (Z position), firstly the desired position to be saved must be selected using the buttons labeled “Foc 1” through “Foc 4” or the “top plane” 86a and “bottom plane” 86b buttons. Actuating the “Save current Focus” button and then pressing the “OK” button performs the save. Triangle 52 appears and flashes for 3 seconds to visualize the save operation and indicate the meaning of the triangle (location occupied). The procedure for clearing a saved focus plane begins with selection of the buttons labeled “Foc 1” through “Foc 4” or the “top plane” or “bottom plane” button, which indicate the position to be cleared. Actuation of the “Clear” button enables the clear operation, which is confirmed by pressing the “OK” button. Occupied and callable memory locations are labeled with a triangle. The “Display all” button is used to display all saved stage positions. Warnings to the user corresponding to those in FIGS. 8b and 8c are similarly provided when stage positions are saved or cleared.

FIG. 8f depicts the memory menu with a display of the saved focus planes (Z positions). A simplified display of all saved focus planes (Z positions) in a coordinate system is shown on display 8 for approximate orientation. The Z axis of the coordinate system is labeled “Foc” on display 8.

FIG. 8g depicts the start page for saving system settings. It is an information page 87 for the “Memo” function. This page is shown on display 8 only in “Normal” mode, and appears only twice after each system start. The information for the user reads “Memo allows you to save current microscope settings and optionally the focus position, but not the stage position.”

FIG. 8h depicts memory menu 21e for clearing and/or saving system settings. To identify the activity, “Setting” button 83 has a dark background. The procedure for loading a saved system setting can be described as follows: Firstly, one of the buttons labeled “MEM 1” through “MEM 6” must be selected. Upon actuation of the “Go To” button, the corresponding system setting is confirmed by pressing the “OK” button. To clear a saved system setting, the first step is to choose the system setting to be cleared by selecting at least one button labeled “MEM 1” through “MEM 6”. Actuation of the “Clear” button enables the clear operation, which is confirmed by pressing the “OK” button. The procedure for saving the current system setting begins with selection of one of the buttons labeled “MEM 1” through “MEM 6”. The save operation is enabled by pressing the “Save setup to” button, and is confirmed by actuating the “OK” button. For the further options of additionally storing the current focus position along with the system settings, a further menu page is called. The indication that focus position has also been saved together with the system settings is given by the addition of “+ FOC” to the respective “MEM” button. A triangle 52 appears on the memory location button and initially flashes for 3 seconds to visualize the save operation and indicate the meaning of the triangle (location occupied). A saved system setting is displayed by pressing the button labeled “Display” on display 8. Buttons for saved system settings can be renamed using the “Rename” button.

FIG. 8i depicts the memory menu for saving the current settings. The selected memory location is displayed (assuming that memory location is still unoccupied; otherwise a system message appears). In the present case the memory location labeled “MEM 5” is not occupied. The option of additionally saving the focus plane or “Focus Position . . . ”, i.e. the Z coordinate, can be selected or not using the buttons labeled “included” or “excluded”. After confirmation with the button labeled “OK”, execution branches back to the previous menu page (see FIG. 8h) and the triangle behind the corresponding memory location flashes for 3 seconds. Here as well, appropriate warning messages can be presented to the user to indicate occupied or unoccupied status.

FIG. 8j depicts the memory menu for quick access to saved system settings. Here the settings stored in memory location “MEM 5” are shown on display 8. Display 8 also contains an indication that the focus plane was not also saved, showing a message 88 “Focus-Position is not saved”.

FIG. 8k depicts memory menu 21e for renaming the buttons for saved system settings. The buttons for saved system settings can be renamed using an alphanumeric keypad block 87 (modeled on a telephone keypad).

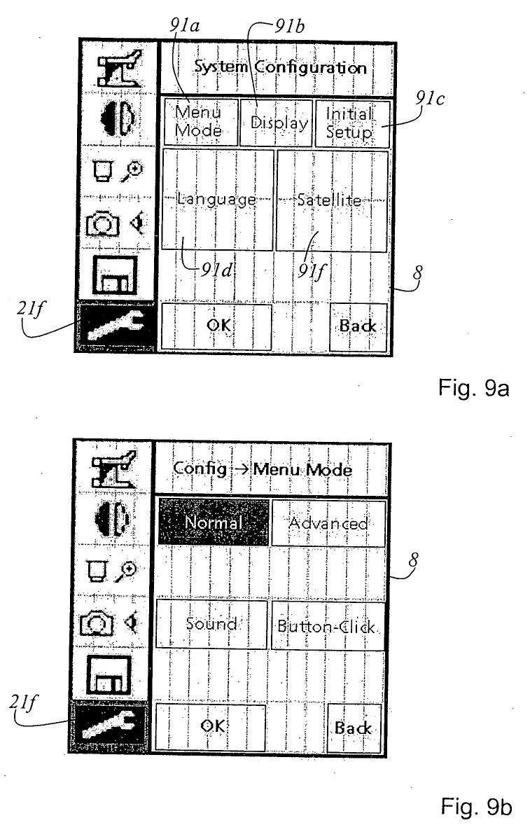

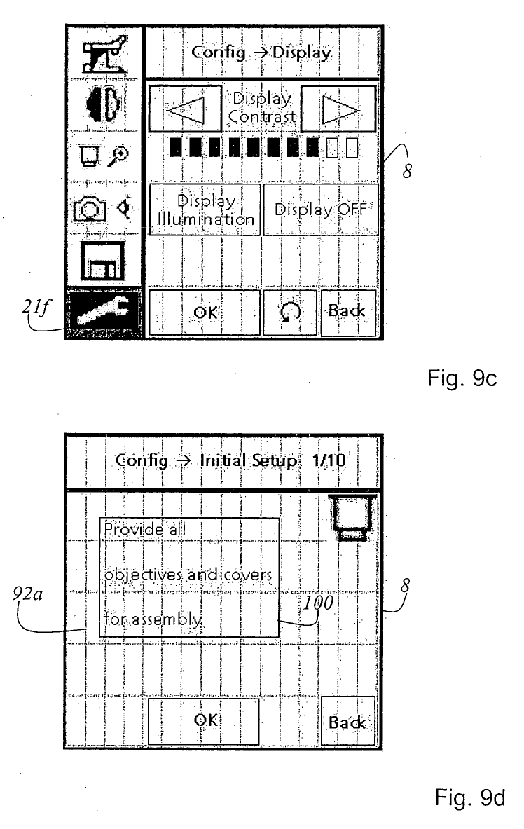

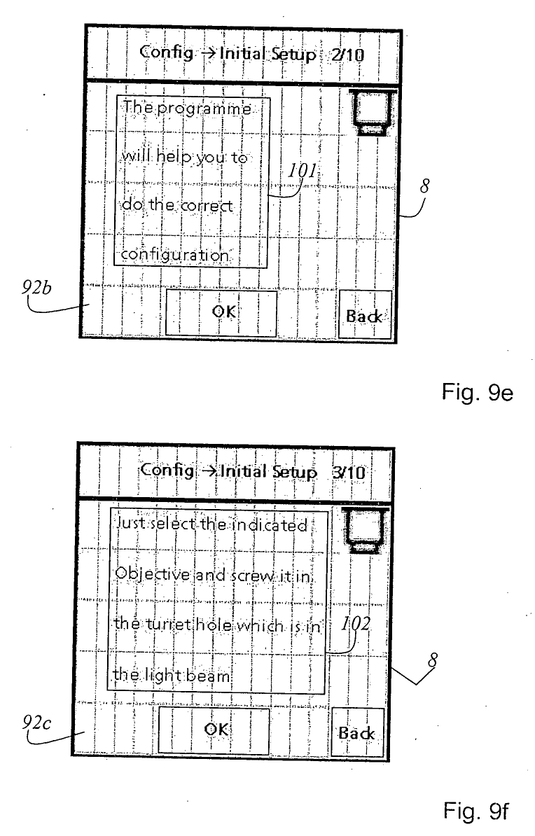

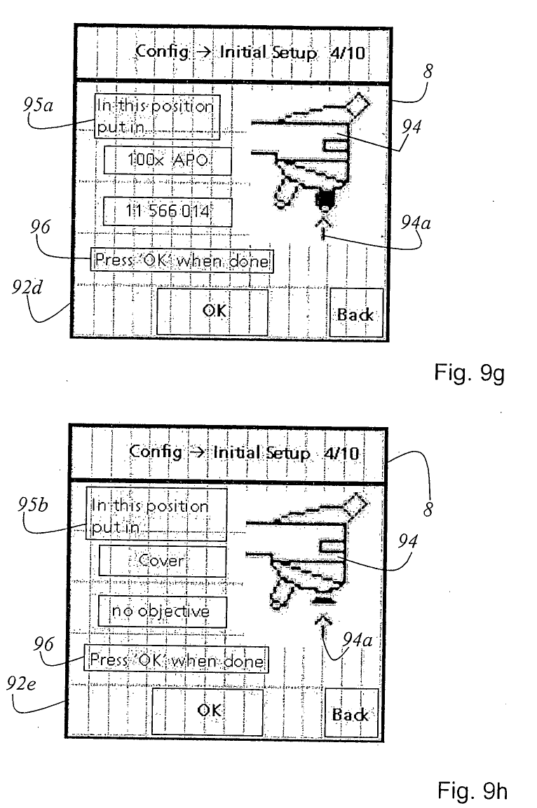

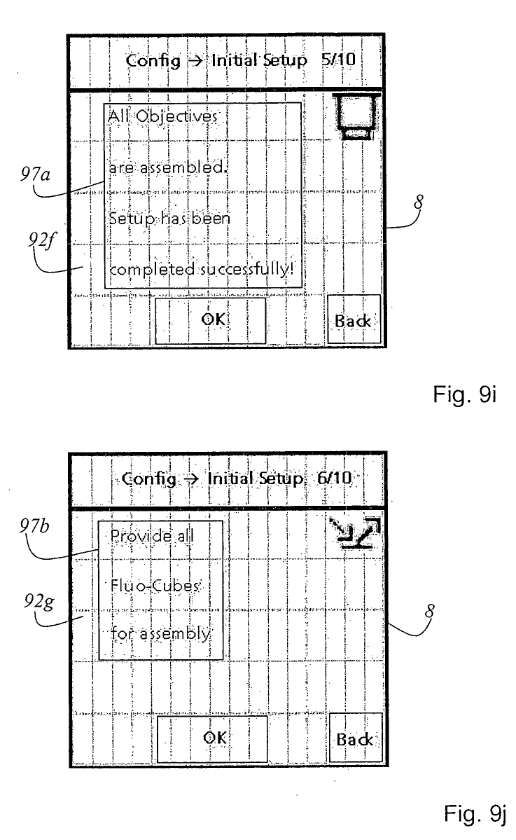

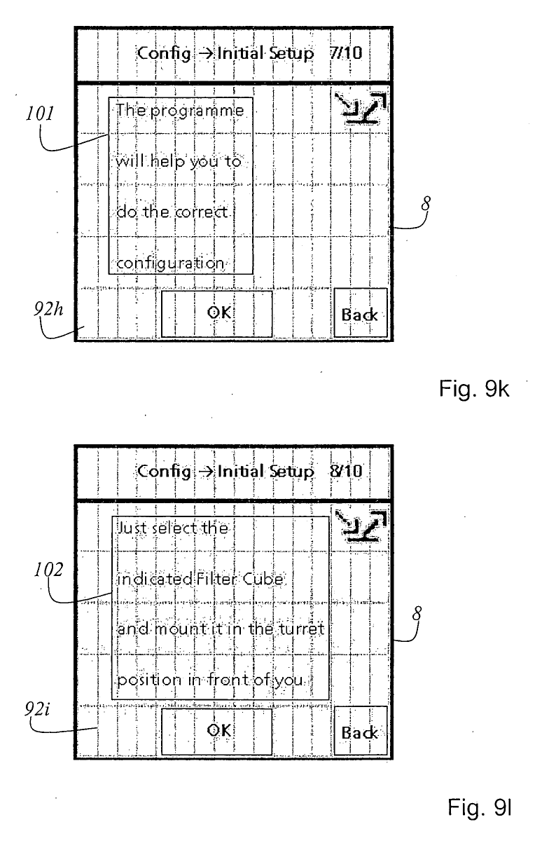

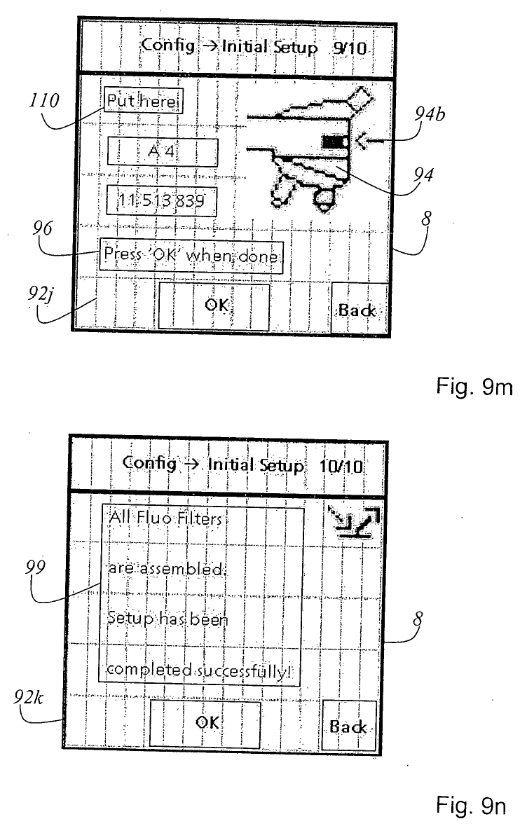

FIG. 9a depicts a configuration menu 21f with which the basic device and system settings can be made. The basic device and system settings can be made in configuration menu 21f. A button 91alabeled “Menu Mode” presents the “normal” and “expert” modes for selection as the interaction method; the expert mode does not require confirmation using the “OK” button. The contrast and brightness of the touchscreen are controlled with a “Display” button 91b. An “Initial Setup” button 91c—which, like a “Language” button 91d, is also briefly presented upon startup (see FIG. 3)—provides user guidance during the initial installation of objectives and fluorescence filters. A “Satellite” button 91f offers expanded settings for an operating satellite, with which various functions of a microscope system can be controlled and called (e.g. various image orientation options). The configuration menu is identified by a stylized wrench on the function switch.

FIG. 9b depicts the configuration menu for menu settings. A “Normal” button represents the normal mode and an “Advanced” button represents the expert mode (in the expert mode, a function selection no longer needs to be confirmed using the “OK” button). In addition, message pages are not displayed in the expert mode. A “Sound” button allows audible feedback to be switched on and off. A “Button-Click” button switches button clicks on and off.

FIG. 9c depicts the configuration menu for display settings. Display contrast can be adjusted using two arrow keys. Between the arrow keys, their function is indicated with “Display Contrast”. The change is made online, and is indicated to the user by way of a scale. The “OK” button must be pressed in order to save the selected value. Backlighting can be switched on and off with a “Display Illumination” button. The “Display OFF” button causes deactivation of display 8 in order to eliminate stray light, in particular when viewing in a darkened environment and when taking photographs.

FIG. 9d is a first depiction 92a of the configuration menu for initial setup of the microscope. The number of pages in the “Initial Setup” menu varies as a function of the number of objectives or fluorescence filters that the customer has to install. The menu assists with step-by-step installation of the components included upon delivery. The start page for completing the system at setup is displayed first. The first step is installation of the objectives and, optionally, the objective turret covers. The user sees on display 8 a request 100 “Please have all objectives and covers ready for installation.”

FIG. 9e is a second depiction 92b of the configuration menu for initial setup of the microscope, for installation of the objectives. Display 8 provides the user with an explanation 101 of the procedure. The user sees explanation 101 “The program will assist you with proper configuration” on display 8.

FIG. 9f is a third depiction 92c of the configuration menu for initial setup of the microscope, for installing objectives. The user sees on display 8 a description 102 of the procedure to be performed. This description 102 reads “Select the objective indicated, and thread it into the turret opening now located in the beam path.”

FIG. 9g is a fourth depiction of configuration menu 92d for initial setup of the microscope, for installing objectives. The user is given a procedural instruction describing the position at which a specific objective must be inserted. Display 8 shows a stylized microscope turret 94 on which the objective to be inserted is marked with an arrow 94a, along with the instruction 95a “At this position insert objective”. Pressing the “OK” button activates rotation to the next position, and the user receives a message 96a “Press OK when done.” Display 8 also indicates the name and item number of the objective to be installed.

FIG. 9h depicts configuration menu 92e for initial setup of the microscope, for inserting covers. The covers are inserted at objective turret positions where an objective is not installed. The user receives procedural instruction 95b reading “Install a cover at this position.” Rotation to the next position is activated by pressing the “OK” button, and the user once again receives the message 96a “Press OK when done.” The indication of the name and item number of the objective is replaced by a notification that an objective is not to be installed at this position.

FIG. 9i depicts configuration menu 92f for completing objective installation. The user receives message 97a “All objectives installed Setup completed succesfully” on display 8.

FIG. 9j is a first depiction of configuration menu 92g for installing the fluorescence filters. On the start page for completing the system upon setup, the user receives instruction 97b “Please have all Fluo-Cubes ready for installation.”

FIG. 9k is a second depiction of configuration menu 92h for installation of the fluorescence filters. On display 8, the user receives an explanation of the procedure. The user sees explanation 101 “The program will assist you with proper configuration” on display 8.

FIG. 9l is a third depiction of configuration menu 9i for installing the fluorescence filters. The user receives description 102 of the procedure to be followed, which reads “Select the appropriate filter cube and insert it into the filter wheel position in front of you.”

FIG. 9m is a fourth depiction of configuration menu 92j for installing the fluorescence filters. The user receives a procedural instruction describing the position at which a specific fluorescence filter must be inserted. Display 8 shows a stylized microscope turret 94 on which the position at which the fluorescence filter is to be inserted is marked with an arrow 94b. Instruction 110 “Insert here” is outputted on display 8. Rotation to the next filter position is activated by pressing the “OK” button, and the user receives message 96 “Press OK when done.” Display 8 also shows the name and item number of the filter type to be installed.

FIG. 9n depicts configuration menu 92k for completing installation of the fluorescence filters. The user receives on display 8 a message 99 “All fluo filters installed Setup completed successfully.”

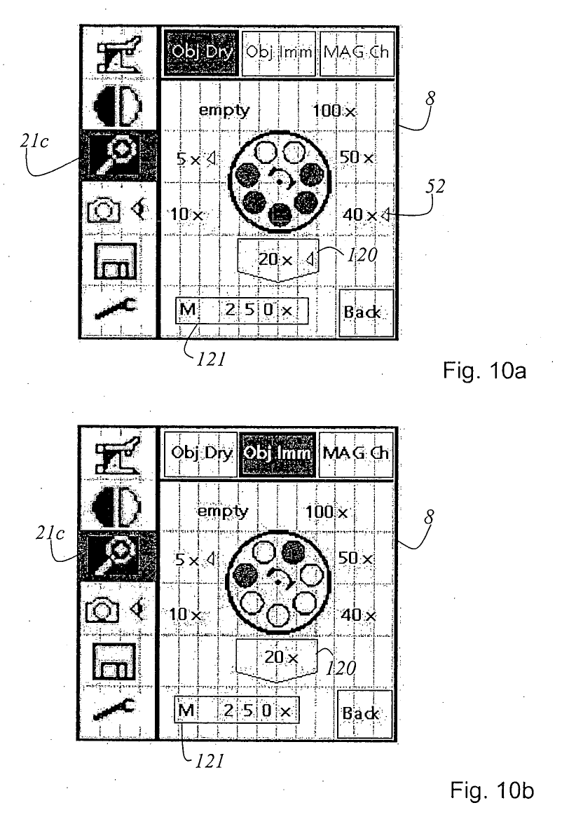

In the description that follows, in contrast to the description above, the menu pages for a partially automated microscope system must also be disclosed. FIG. 10a depicts objective menu 21c for dry objectives, for a non-motorized objective turret. The objective menu must be modified correspondingly because the objective turret is not motorized, since selection of the desired objective can no longer be performed on the touchscreen. Display 8 depicts an objective turret as a circle, within which smaller circles represent the positions of the objectives.

In addition to the objective turret, display 8 also indicates which objectives are available and are compatible with the currently selected setting. A separate depiction for dry objectives (“Obj Dry”) and immersion objectives (“Obj Imm”) is retained. The menu pages for the “MAG Changer” (secondary magnification) are unchanged. The orientation and position of the objectives are reflected in the depiction on display 8. Upon rotation of the objective turret, the position of the objectives in the depiction also changes. The objective located in the light path is indicated on the display by a border 120. Objectives that are suitable for microscopy without immersion oil are marked in the depiction of the turret. Triangles 52 next to the objective name serve to recommend those objectives that are compatible with previous system settings (e.g. contrasting techniques). Display 8 also gives an indication 121 of the current total magnification.

FIG. 10b depicts objective menu 21c for immersion objectives (“Obj Imm”) for a non-motorized objective turret. Objectives for microscopy using immersion oil are marked in the depiction of the turret. Triangles once again serve as a recommendation to indicate objectives that are compatible with previous system settings (contrasting techniques). Combination objectives are identified both in the menu for dry objectives and in the menu for immersion objectives. Display 8 also gives an indication 121 of the current total magnification.

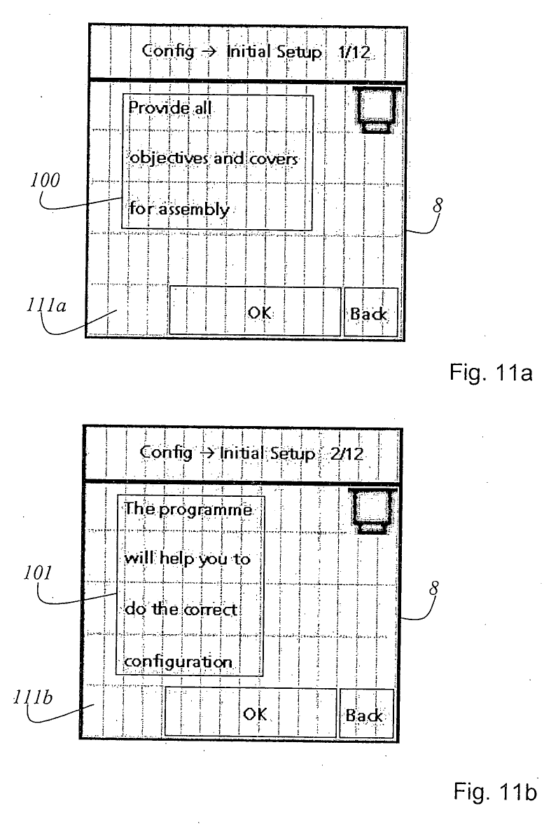

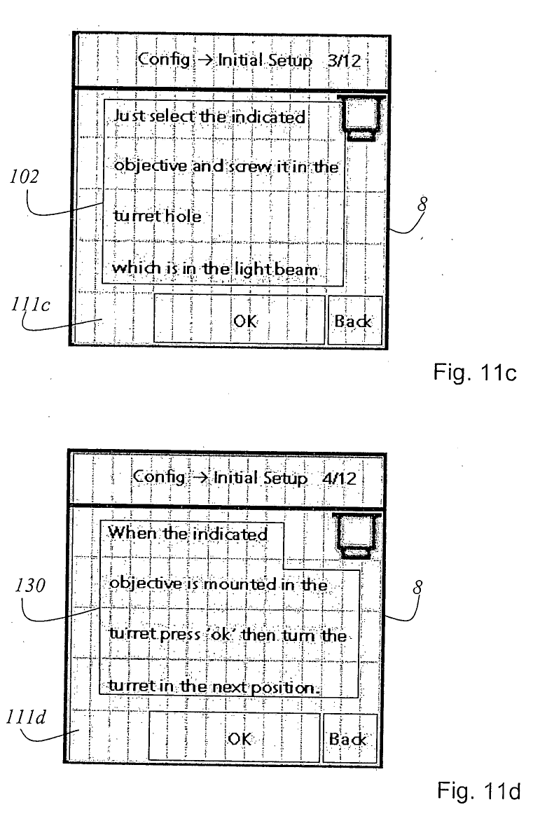

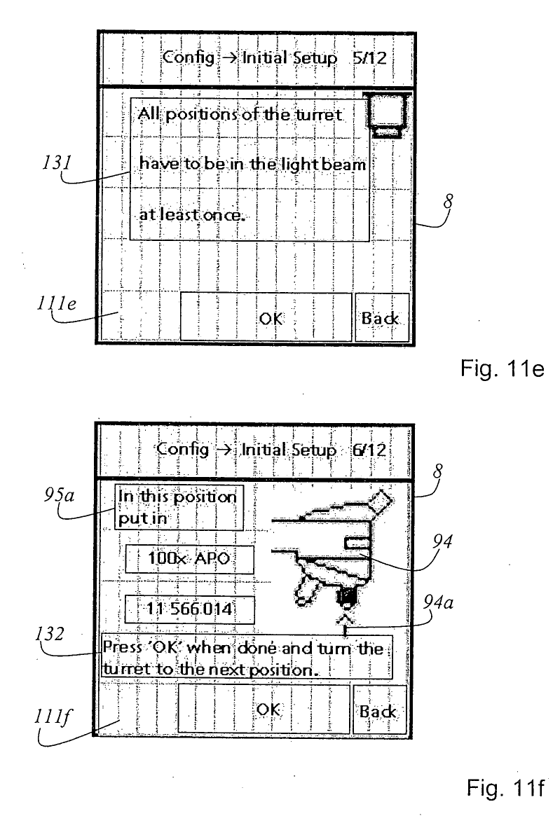

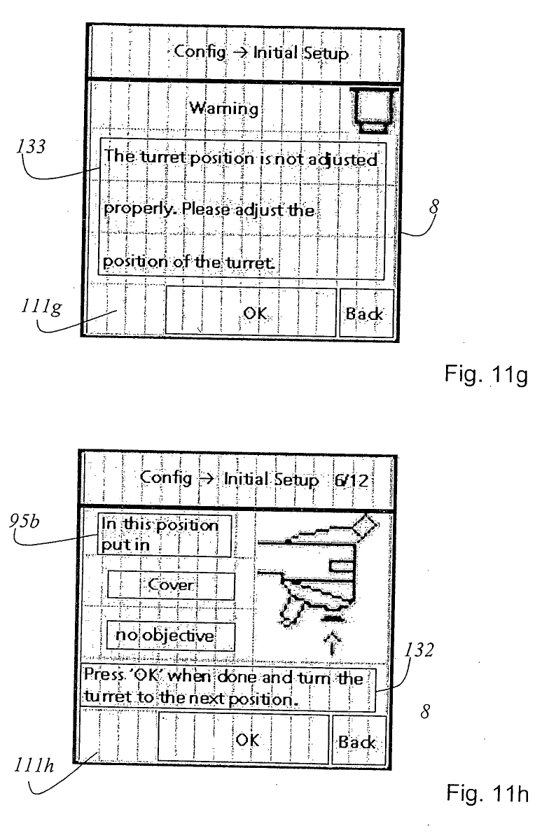

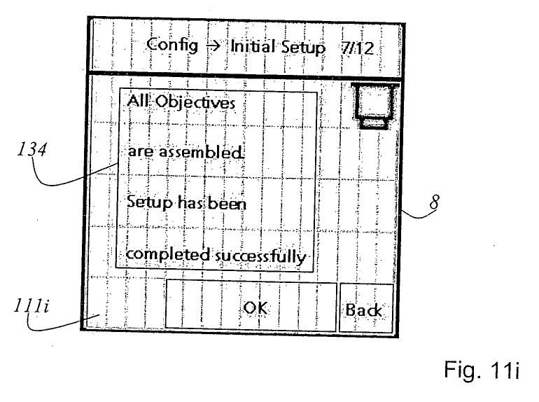

FIG. 11a is a first depiction 111a of the configuration menu for initial setup of the microscope, for installing objectives on a non-motorized objective turret. The procedure to be selected for the initial setup menu pages is once again different from that for an automatic microscope system. An objective turret position for installing a specific objective must be set manually. The number of pages in the “Initial Setup” menu once again varies depending on the number of objectives and fluorescence filters that the customer has to install. The menu pages for installing the fluorescence filters remain unchanged. Installation of the objectives, and optionally of covers for the objective turret, is performed first. The user sees request 100 “Please have all objectives and covers ready for installation” on display 8.

FIG. 11b is a second depiction 111b of the configuration menu for initial setup of the microscope, for installing objectives on a non-motorized objective turret. On display 8, the user receives an explanation of the procedure. The user sees explanation 101 “The program will assist you with proper configuration” on display 8.

FIG. 11c is a third depiction 111c of the configuration menu for initial setup of the microscope, for installing objectives on a non-motorized objective turret. The user sees on display 8 a description 102 of the procedure to be performed. This description 102 reads “Select the objective indicated, and thread it into the turret opening now located in the beam path.”

FIG. 11d is a fourth depiction 111d of the configuration menu for initial setup of the microscope, for installing objectives on a non-motorized objective turret. The user sees a procedural instruction describing the position at which a specific objective must be inserted. Procedural instruction 130 reads “When the indicated objective has been mounted in the turret, press ‘OK’ and rotate the turret to the next position.” Rotation to the next position must be performed manually after pressing the “OK” button.

FIG. 11e is a fifth depiction 111e of the configuration menu for initial setup of the microscope, for installing objectives on a non-motorized objective turret. An additional message 131 “Each turret position must be in the beam path at least once” is displayed to the user on display 8. For correct installation of the objectives, each objective turret position must be located in the beam path at least once. Only then can the system provide the appropriate installation instruction for each position.

FIG. 11f is a sixth depiction 111f of the configuration menu for initial setup of the microscope, for installing objectives on a non-motorized objective turret. The user receives a procedural instruction describing the position at which a specific objective must be inserted. Display 8 depicts a stylized microscope turret 94 on which the objective to be inserted is marked with an arrow 94a. Display 8 outputs instruction 95a “At this position insert objective.” Rotation to the next position is activated by pressing the “OK” button, and the user receives a message 132 “Press ‘OK’ when done, and rotate the objective turret to the next position.” Display 8 also indicates the name and item number of the objective to be installed.

FIG. 11g is a depiction 111g of a warning 133 issued when the objective is not inserted correctly into a non-motorized objective turret. If the objective turret position is not correctly aligned, the user is requested to rotate the objective turret to the next click-stop position and align it correctly. Warning 133 reads “The objective turret position is not set correctly. Please adjust the objective turret position.”

FIG. 11h is a depiction 111h of the configuration menu for initial setup of a microscope with a non-motorized objective turret, for inserting covers. The covers are inserted at objective turret positions where an objective is not or will not be installed. The user receives procedural instruction 95b with the description “Insert a cover at this position.” Rotation to the next position is activated by pressing the “OK” button, and the user receives a message 132 “Press ‘OK’ When done, and rotate the objective turret to the next position.” The indication of the objective name and item number is replaced by a notification that no objective is to be inserted at this position.

FIG. 11i is a depiction 111i of the configuration menu for completing objective installation on a non-motorized objective turret. The user receives message 134 “All objectives installed. Setup completed successfully.” on display 8.

The invention has been described with reference to a particular embodiment. It is apparent to one skilled in the art, however, that changes and modifications can be made without thereby leaving the range of protection of the claims.

What is claimed is:

1. A device for controlling functions of a microscope system, comprising: a stand base portion of a microscope, a central display integrated into the stand base portion, wherein the central display is used to perform all settings of the microscope system, to call saved settings of the microscope system and to receive warning messages or notifications from the microscope system.

2. The device as defined in claim 1, wherein the display contains an operating menu and an information mode, the operating menu being constructed from a first region, a second region, and a third region, and a main menu being displayable in the first region, a submenu in the second region, and information and action elements in the third region, the third region being delimited on one side by the main menu and on one side by the submenu, and the entire display being usable for presentation in the information mode.

3. The device as defined in claim 1, wherein the main menu is constructed from multiple sub-main menus; and depending on the selection of the sub-main menu by the user, a respective submenu corresponding to the selected sub-main menu is displayable on the display.

4. The device as defined in claim 1, wherein the display is a touchscreen.

5. The device as defined in claim 1, wherein a plurality of function switches of callable sub-main menus are displayable and activatable on the display, at least one function of the selected sub-main menu being displayable and activatable in the second region; and data and settings of the microscope system corresponding to the selected function of the selected sub-main menu are displayed in the third region.

6. The device as defined in claim 5, wherein the first region and the second region are arranged perpendicular to one another.

7. The device as defined in claim 1, wherein the main menu is constructed from six different function switches, with each of which a sub-main menu of the main menu can be called.

8. The device as defined in claim 7, wherein the first sub-main menu is a setup display that is identified by a stylized microscope on the function switch.

9. The device as defined in claim 7, wherein the second sub-main menu is a contrast menu that is identified by a light and a dark circle segment on the function switch.

10. The device as defined in claim 7, wherein the third sub-main menu is an objective menu that is identified by a stylized objective and a stylized magnifying glass on the function switch.

11. The device as defined in claim 7, wherein the fourth sub-main menu is a port menu that is identified by a stylized camera and a stylized human eye on the function switch.

12. The device as defined in claim 7, wherein the fifth sub-main menu is a memory menu that is identified by a stylized diskette on the function switch.

13. The device as defined in claim 7, wherein the sixth sub-main menu is a configuration menu that is identified by a stylized wrench on the function switch.

14. A method for controlling functions of a microscope system, comprising the steps of:
providing a display integrated into a stand base part of the microscope system;
activating the display and thereby displaying an operating menu and information mode, wherein the operating menu being constructed from a first region, a second region, and a third region;
displaying a main menu in the first region,
displaying a submenu the second region,
displaying information and action elements in the third region, wherein the third region being delimited on one side by the main menu and on one side by the submenu; and
using the entire display for presentation in the information mode.

15. The method as defined in claim 14, wherein the main menu is constructed from multiple sub-main menus; and depending on the selection of the sub-main menu by the user, a respective submenu corresponding to the selected sub-main menu is displayable on the display.

16. The method as defined in claim 14, wherein the display is a touchscreen.

17. The method as defined in claim 14, wherein the main menu is constructed from six different function switches, with each of which a sub-main menu of the main menu is callable.

18. The method as defined in claim 14, wherein the method is implemented by a computer associated with the microscope system; and the microscope system is equipped with multiple motors and multiple sensors or codes.

19. The method as defined in claim 18, wherein during a configuration, the computer learns how the microscope system is equipped.

20. The method as defined in claim 18, wherein the method activates the various motors and obtains data concerning their settings.

21. The method as defined in claim 18, wherein by way of the display, the method makes available to the user notifications as to which configuration of the microscope system, of those available, is best suited for the desired examination.

22. The method as defined in claim 18, wherein by actuating a function key on the display, the user can restore a setting saved by the method in the computer.

23. The method as defined in claim 22, wherein the saved settings can be a specific Z position of the X/Y stage with a specific objective, or a specific Z position of the X/Y stage with the objective currently in use, or a specific position of the X/Y stage in the X/Y plane.

24. The method as defined in claim 14, wherein a start page is displayed once on the display each time the microscope system is switched on; the start page occupies the entire display; and the start page indicates the firmware version in a first region and enables a language selection by way of a first selection button and direct access to the initial setup with a second selection button.

25. The method as defined in claim 17, wherein a first sub-main menu makes available a setup display with which general settings of the microscope system are presented so as to provide information about the overall operating state of the microscope system.

26. The method as defined in claim 17, wherein a second sub-main menu is provided that is a contrast menu in which the available contrasting techniques are selected; and triangles are associated in the display with the various indications representing a contrasting technique compatible with the previous settings.

27. The method as defined in claim 17, wherein a third submenu is provided that encompasses separate submenus for dry objectives, immersion objectives, and the magnification changer; and triangles indicate those objectives that are compatible with previous system settings (e.g. contrasting techniques).

28. The method as defined in claim 17, wherein a fourth sub-main menu is provided which is a port menu and indicates the currently set viewing output and allows selection of the available output.

29. The method as defined in claim 17, wherein a fifth sub-main menu is provided which is a memory menu and enables a plurality of memory functions for clearing, setting, and saving the current stage position, multiple focus planes, and multiple operating states.

30. The method as defined in claim 17, wherein a sixth sub-main menu is provided which is a configuration menu with which basic device and system settings can be made.
